(19) United States
(12) Patent Application Publication
(10) Pub. No.: US 2026/0175831 A1
(43) Pub. Date: Jun. 25, 2026

(54) PARKING A VEHICLE WITH AN ATTACHMENT

(71) Applicant: Robert Bosch GmbH, Stuttgart (DE)

(72) Inventor: Jebin Joy, Canton, MI (US)

(21) Appl. No.: 18/987,000

(22) Filed: Dec. 19, 2024

(51) Int. Cl. B60W 30/06; B60W 10/20; B60W 50/00; B60W 50/14; G06V 10/75; G06V 20/58

(52) U.S. Cl. CPC B60W 30/06; B60W 10/20; B60W 50/0098; B60W 50/14; G06V 10/751; G06V 20/586; B60W 2050/0026; B60W 2420/403; B60W 2420/408; B60W 2530/201; B60W 2710/20

(57) ABSTRACT

Examples provide a system for a vehicle with sensors configured to sense data related to a vehicle steering system that includes a motor and a steering rack. The system includes an electronic processor communicatively connected to the plurality of vehicle sensors and configured to determine a size of the vehicle. The electronic processor determines a size of the attachment. The electronic processor generates a trajectory path along which the vehicle and attachment can travel to park. The electronic processor generates an automatic parking maneuver based on the trajectory path to park the vehicle with the attachment.

### FIELD

Aspects described herein relate to, among other things, a method and system for parking a vehicle with an attachment and, in one example, for automatically parking an autonomous or semi-autonomous vehicle with an attachment.

### SUMMARY

Systems for assisting a driver in operating a vehicle are included in semi-autonomous and autonomous vehicles. These systems include parking assist systems in which the driver is assisted, during a parking process, via instructions or automatic steering wheel control. Some automated or semi-autonomous parking systems require a vehicle driver to train the parking assist systems on a particular trajectory that they wish the vehicle to subsequently follow to park.

Based on the trained trajectory, an automated or semi-autonomous vehicle parks itself in the trained location. Hence, after training the trajectory, the vehicle performs a parking maneuver along the trained trajectory. In such a case, the vehicle may use environmental sensors to compare newly sensed environment information to the previously stored trajectory information to work out its position relative to the stored trajectory, which is then used to make decisions on how to maneuver the vehicle until it eventually parks.

One downfall associated with trained trajectories, is that they are based on the most frequent driving habits of a driver. Aspects herein focus on, among other things, utilizing the trained trajectories to establish parking in less frequent situations, such as when towing a vehicle.

In some aspects, the techniques described herein relate to a system for parking a vehicle with an attachment, the system including: a plurality of vehicle sensors configured to sense data related to a vehicle steering system that includes a motor and a steering rack; and an electronic processor communicatively connected to the plurality of vehicle sensors and configured to: determine a size of the vehicle; determine a size of the attachment; determine a parking slot dimension; generate a trajectory path along which the vehicle and attachment can travel to park in a parking slot; generate an automatic parking maneuver based on the trajectory path; and control the vehicle to park the vehicle with the attachment.

In some aspects, the techniques described herein relate to a method for automatically parking a vehicle, the method including: determining a size of the vehicle; determining a size of an attachment attached to the vehicle by implementing, with an electronic processor, at least one algorithm; generating a trajectory path along which the vehicle and the attachment can travel to park by utilizing a close match parking maneuver; generating an automatic parking maneuver; and controlling the vehicle according to the automatic parking maneuver to park the vehicle with the attachment along the trajectory path.

Other aspects will become apparent by consideration of the detailed description and accompanying drawings.

### BRIEF DESCRIPTION OF THE DRAWINGS

FIG. 1 illustrates a vehicle and an attachment, according to some aspects.

FIG. 2 schematically illustrates the vehicle with an electronic controller according to some aspects.

FIG. 3 illustrates an example of the electronic controller according to some aspects.

FIG. 4 illustrates a diagram of a parking system for parking the vehicle and attachment according to some aspects.

FIG. 5 illustrates an attachment size determination block diagram for the parking system of according to some aspects.

FIG. 6 illustrates a schematic for an attachment image database according to some aspects.

FIG. 7 illustrates an image look-up algorithm implemented with the electronic controller according to some aspects.

FIG. 8 illustrates an attachment-size algorithm implemented with the electronic controller according to some aspects.

FIG. 9 illustrates a radar algorithm implemented with the electronic controller according to some aspects.

FIG. 10 illustrates stored parking maneuver information in the form of a maneuver look-up table according to some aspects.

FIG. 11 illustrates the parking algorithm implemented with the electronic controller according to some aspects.

FIG. 12 illustrates an example method for automatically parking a vehicle according to some aspects.

### DETAILED DESCRIPTION

Before any embodiments, examples, features, and aspects are explained in detail, it is to be understood that the disclosure is not limited in its application to the details of construction and the arrangement of components set forth in the following description or illustrated in the following drawings. The embodiments, examples, features, and aspects are capable of other implementations and of being practiced or of being carried out in various ways.

Also, it is to be understood that the phraseology and terminology used herein is for the purpose of description and should not be regarded as limiting. The terms “mounted,” “connected,” and “coupled” are used broadly and encompass both direct and indirect mounting, connecting, and coupling. Further, “connected” and “coupled” are not restricted to physical or mechanical connections or couplings, and can include electrical connections or couplings, whether direct or indirect. Also, electronic communications and notifications may be performed using known means including wired connections, wireless connections, etc.

The disclosure herein generally relates to autonomous and semi-autonomous vehicles including parking software for parking a vehicle with an attachment, e.g., a trailer hitched to the vehicle. Existing solutions are based on trained information associated with and stored in a storage of the training vehicle. This trained information is generally based on typical driving scenarios by a driver of the vehicle. However, this does not account for the possibly less frequent scenario when a trailer is attached.

Furthermore, training requires a large amount of memory (sometimes referred to as “storage volume”). Even more memory is needed to accommodate for multiple users and multiple trajectories in multiple zones. This increases the cost of the system and impacts (or slows) runtime, as multiple trajectories may need to be processed.

In some instances, the parking software described herein utilizes information from predetermined stored scenarios and environment surroundings sensed in real-time. In one aspect, an existing parking maneuver is altered for when a trailer or other objects are attached to the vehicle. In some instances, the parking software automatically calculates the size of the vehicle with the attachment and offers a parking maneuver to the user based on these inputs even if there is no existing, e.g., learned, parking maneuver available. For example, in an event the vehicle is undergoing the parking maneuver for the first time, e.g. for a new vehicle.

In some instances, dimensions associated with the attachment may be uploaded from a database in accordance with images captured from a camera attached to the vehicle. Image recognition techniques may include machine learning algorithms to identify the image. Machine learning algorithms or Artificial Intelligence (AI) algorithms could also be used for functionalities including, but not limited to, image detection, parking lot detection, trajectory path planning, and/or deriving a close match parking maneuver. In an event the database and/or dimensions associated with the vehicle are not available, techniques for evaluating the attachment, e.g., radar along with DBSCAN, may be used to determine dimensions of the attachment. Similarly, techniques used for evaluating the attachment may be used to evaluate the surrounding environment. Subsequently, an analysis, e.g., utilizing DBSCAN and data from Camera, of the surrounding environment is done to determine the size of an empty space, e.g., a parking slot, and whether or not the vehicle and the attachment will fit into the empty space. In the event the vehicle and attachment do fit, an updated parking maneuver with the attachment may be offered to a user for autonomously or semi-autonomously parking the vehicle with the attachment in the empty space. In some instances, the existing parking maneuver is a learned parking maneuver adapted to a user's preferred method of parking over time.

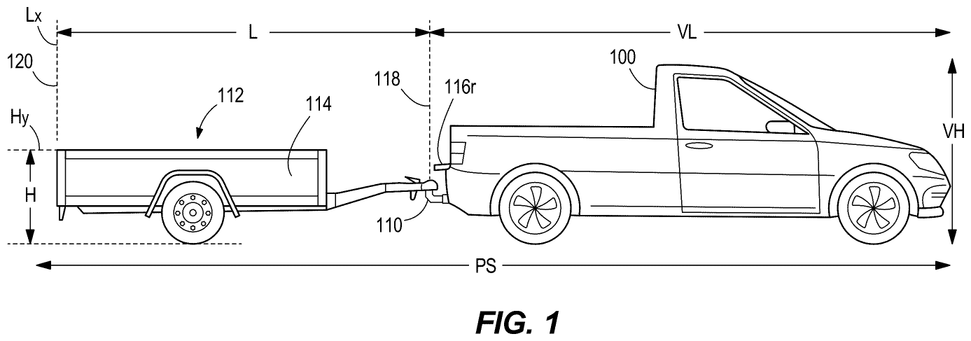

FIG. 1 illustrates a vehicle 100 according to some aspects. In some instances, the vehicle 100 is an autonomous vehicle. The term “autonomous vehicle” is used in an inclusive way to refer to an autonomous or partially autonomous vehicle, which possesses varying degrees of automation (that is, the vehicle is configured to drive itself with limited, or in some cases no, input from a driver). The term “driver,” as used herein, generally refers to an occupant of a vehicle, who operates the controls of the vehicle or provides control input to the vehicle to influence the operation of the vehicle. However, in some instances, the vehicle 100 is not an autonomous vehicle.

In the example shown, the vehicle 100 includes a hitch 110. An attachment 112, by way of example a trailer 114, is attached to the hitch 110. The vehicle 100 may include multiple cameras including a rear-view camera 116r. The rear-view camera 116r may be attached to a rear 118 of the vehicle 100 or may be integral with the rear 118 of the vehicle 100.

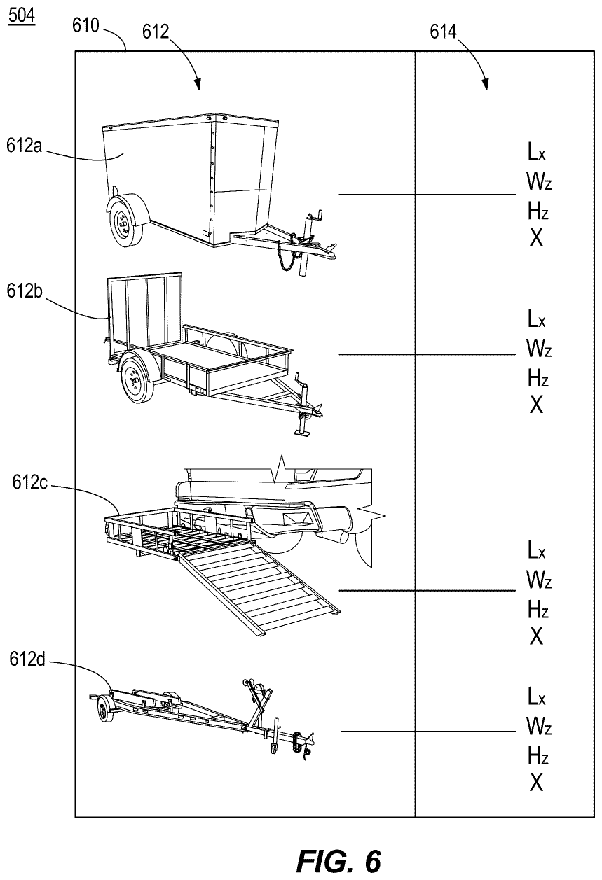

Dimensions associated with the attachment 112 may be stored in the memory 308 (FIG. 3). The dimensions vary with the type of attachment 112. In some aspects, the trailer 114 has a length (“L”) stored as a first geometric offset Lx. The first geometric offset Lx may be equal to the distance from the rear 118 of the vehicle to a rear 120 of the attachment 112. A width (“W” into the page) of the attachment 112 is stored as a second geometric offset Wz. A height (“H”) of the attachment is stored as a third geometric offset Hy. All of the offsets Lx, Wz, Hy, may be stored, by way of example, in a feature look-up table as illustrated in FIG. 6 (in the memory 308 FIG. 3). When the attachment 112 is not present, the offsets may default to zero.

Dimensions associated with the vehicle 100 may be stored in the memory 308 (FIG. 3). The vehicle dimensions may include a vehicle length (“VL”), a vehicle height (“VH”), and a vehicle width (into the page). When the attachment 112 is present, the dimensions of the attachment and the dimensions of the vehicle 100 together define a parking slot dimension (“PS”), illustrated as a straight line. It should be understood, however, that the parking slot dimension PS is a three dimensional and represents the needed space for parking the vehicle 100 and attachment 112.

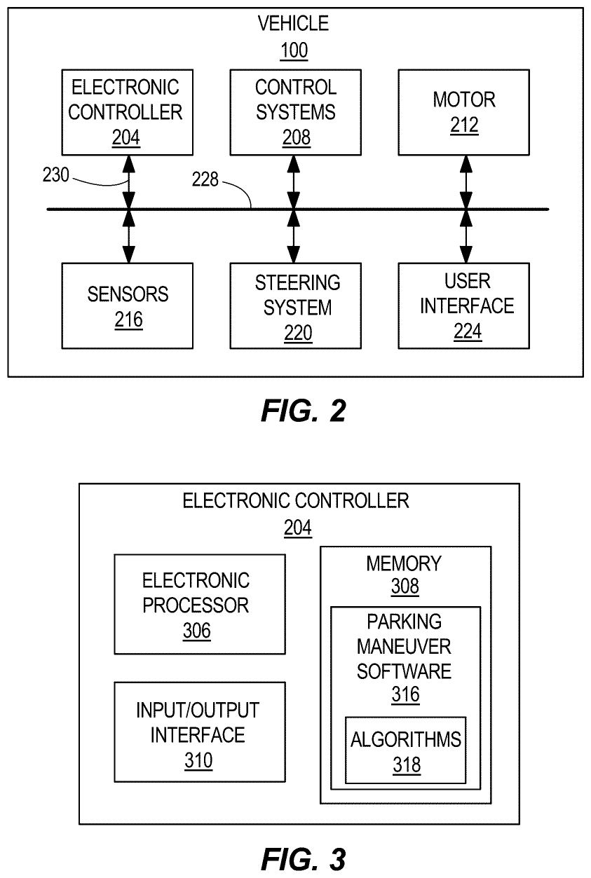

FIG. 2 schematically illustrates the vehicle 100, according to some aspects. In the illustrated example, the vehicle 100 includes an electronic controller 204, vehicle control systems 208, a motor 212, a plurality of sensors 216 installed on the vehicle 100, a steering system 220 (e.g., including a steering wheel, steering rack, one or more steering axles, tires, etc.) for steering a front and/or rear axle of the vehicle 100, and a user interface 224. The components of the vehicle 100, along with other various modules and components are electrically and communicatively coupled to each other via direct connections or by or through one or more control or data buses (for example, the bus 228), which enable communication therebetween. The bus 228 may provide a signal 230, including, among other things, information regarding an attachment status, (FIG. 5, e.g., whether an attachment, e.g. the trailer 114, is attached to the vehicle 100). The use of control and data buses for the interconnection between, and communication among, the various modules and components would be known to a person skilled in the art. In some instances, the bus 228 is a controller area network (CAN) bus. In some instances, the bus 228 is an automotive Ethernet, a FlexRay™ communications bus, or another suitable bus. In some instances, some or all of the components of the vehicle 100 may be communicatively coupled using suitable wireless modalities (for example, Bluetooth™ or near field communication connections).

The electronic controller 204 (described in greater detail below with respect to FIG. 2) communicates with vehicle control systems 208 and the sensors 216. The electronic controller 204 may receive sensor data from the sensors 216 and determine control commands for the vehicle 100. The electronic controller 204 transmits the control commands to, among other things, the vehicle control systems 208 to operate or assist in operating the vehicle 100 (for example, by generating braking signals, acceleration signals, steering signals). In some instances, the electronic controller 204 is part of one or more vehicle controllers that implement autonomous or partially autonomous control of the vehicle 100.

The vehicle control systems 208 may include controllers, actuators, and the like for controlling aspects of the operation of the vehicle 100 (for example, acceleration, braking, shifting gears, and the like). The vehicle control systems 208 communicate with the electronic controller 204 via the bus 228.

The sensors 216 measure one or more attributes of the vehicle 100 and the environment around the vehicle 100 and communicate information regarding those attributes to the other components of the vehicle 100 using, for example, messages transmitted on the bus 228. The sensors 216 may include, for example, one or multiple of different classes of environment sensors including ultrasonic sensors, lidar-based sensors, radar-based sensors, cameras, or others to monitor the environment. Additional sensors including sensors that detect accelerator pedal position and brake pedal position, wheel speed sensors, steering angle sensors, vehicle speed sensors, yaw, pitch, and roll sensors, Hall effect sensors, force sensors, torque sensors, and rotor position sensors are also contemplated. In some instances, the sensors 216 are similar to sensor sets used in an electronic stability control (ESC) system and similar vehicle control systems.

In some instances, the electronic controller 204 controls aspects of the vehicle 100 based on commands received from the user interface 224. The user interface 224 provides an interface between the components of the vehicle 100 and an occupant (for example, a driver) of the vehicle 100. The user interface 224 is configured to receive input from the driver, receive indications of vehicle status from the system's controllers (for example, the electronic controller 204), and provide information to the driver based on the received indications. The user interface 224 provides visual output, such as, for example, graphical indicators (for example, fixed or animated icons), lights, colors, text, images, combinations of the foregoing, and the like. The user interface 224 includes a suitable display mechanism for displaying the visual output, such as, for example, a liquid crystal display (LCD) touch screen, or an organic light-emitting diode (OLED) touch screen), or other suitable mechanisms. In some instances, the user interface 224 displays a graphical user interface (GUI) (for example, generated by the electronic controller 204 and presented on a display screen) that enables a driver or passenger to interact with the vehicle 100. The user interface 224 may also provide audio output to the driver via a chime, buzzer, speaker, or other suitable device included in the user interface 224 or separate from the user interface 224. In some instances, user interface 224 provides haptic outputs to the driver by vibrating one or more vehicle components (for example, the vehicle's steering wheel and the seats), for example, using a vibration motor. In some instances, user interface 224 provides a combination of visual, audio, and haptic outputs.

FIG. 3 illustrates an example of the electronic controller 204, which includes an electronic processor 406 (for example, a microprocessor, application specific integrated circuit, etc.), a memory 308, and an input/output interface 310. The memory 308 may be made up of one or more non-transitory computer-readable media and includes at least a program storage area and a data storage area. The program storage area and the data storage area can include combinations of different types of memory, such as read-only memory (“ROM”), random access memory (“RAM”), electrically erasable programmable read-only memory (“EEPROM”), flash memory, or other suitable memory devices. The electronic processor 406 is coupled to the memory 308 and the input/output interface 310. The electronic processor 406 sends and receives information (for example, from the memory 308 and/or the input/output interface 310) and processes the information by executing one or more software instructions or modules, capable of being stored in the memory 308, or another non-transitory computer readable medium. The software can include firmware, one or more applications, program data, filters, rules, one or more program modules, and other executable instructions. The electronic processor 406 is configured to retrieve from the memory 308 and execute, among other things, software for performing methods as described herein.

In the example illustrated, the memory 308 stores, among other things a parking maneuver software 316. The parking maneuver software 316 utilizes information from predetermined stored scenarios and environment surroundings sensed in real-time. When the attachment 112 is sensed, an existing parking maneuver is altered.

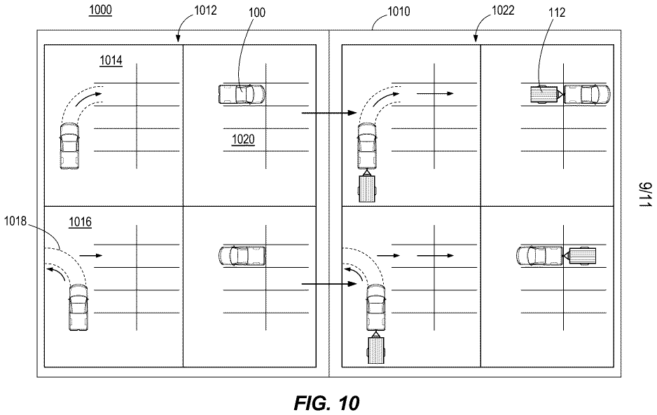

The parking maneuver software 316 may include a plurality of algorithms 318. Using the plurality of algorithms 318 the parking maneuver software 316 will automatically calculate the size of the vehicle 100 with the attachment 112 and derive a close match parking maneuver 1022 (FIG. 10) to the existing parking maneuver accounting for the attachment 112. In another aspect the parking maneuver software 316 derives a parking maneuver based on the size of the vehicle 100 and sensed inputs regarding the surrounding environment.

The input/output interface 310 transmits and receives information from devices external to the electronic controller 204 (for example, components of the vehicle 100 via the bus 228). It should be understood that the electronic controller 204 may include additional components than those illustrated in FIG. 3 and in various configurations. For example, in some examples, the electronic controller 204 includes multiple electronic processors 34, multiple memory modules 36, multiple input/output interfaces 38, or a combination thereof.

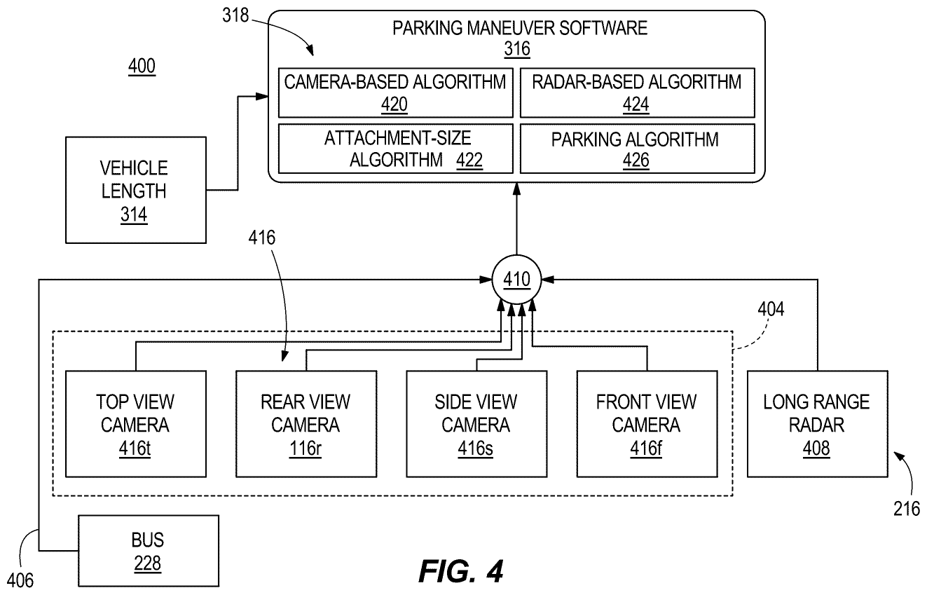

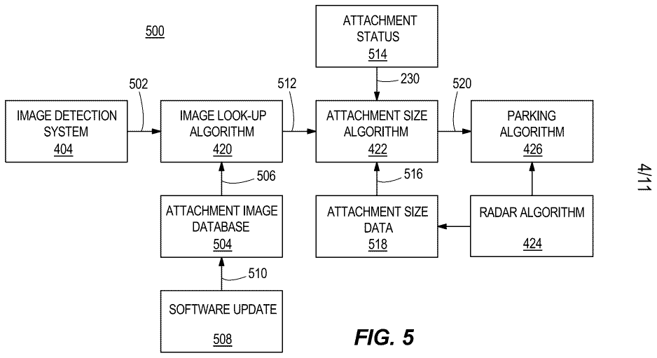

FIG. 4 illustrates a diagram of a parking system 400 for parking the vehicle 100 according to some aspects. The parking system 400 includes the sensors 216. The sensors 216 include a long-range radar 408 and multiple cameras 416, including by way of example, the rear-view camera 116r. The multiple cameras 416 may further include a top view camera 416t, a side view camera 416s, and a front view camera 416f. It should be understood that multiple of each type of camera is contemplated, e.g., the side view camera 416s may be a left-side view camera and a right-side view camera. In some examples, together the multiple cameras 416 define an image detection system 404.

The parking maneuver software 316 is configured to receive or include various inputs. The various inputs include sensor data 410 and a vehicle length 414. The vehicle length 414 is a predetermined known value stored, by way of example, in the memory 308. The sensor data 410 may include, among other things, information collected from the image detection system 404, the long-range radar 408, and the bus 228.

The attachment status 514 may be determined via a tactile sensor configured to register when, for example, the trailer 114 is attached to the vehicle 100. In one example, the tactile sensor is mounted to the hitch 110 on the vehicle 100. The tactile sensor sends a signal to the bus 228 when the trailer 114 is attached to the hitch 110. In another example, the attachment status 514 is determined using one of the multiple cameras 416, by way of example the rear-view camera 116r, to determine whether the trailer 114 is attached to the vehicle 100.

The plurality of algorithms 318 for the parking maneuver software 316 may include an image look-up algorithm 420, an attachment-size algorithm 422, a radar algorithm 424, and a parking algorithm 426 described in more detail with FIGS. 5-10.

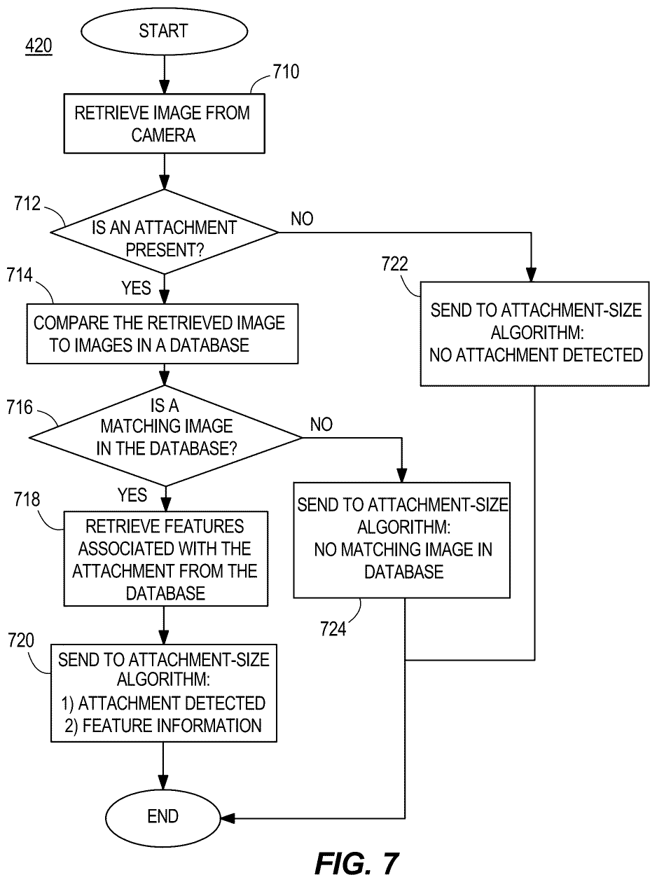

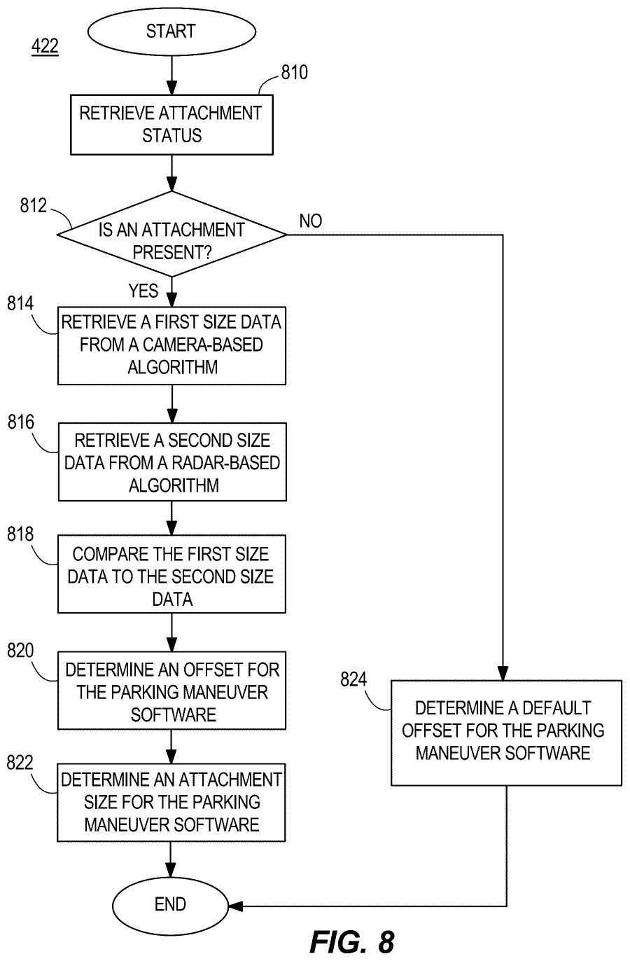

FIG. 5 illustrates a communication block diagram 500 between software and hardware components of the parking system 400 for determining a size of the attachment 112. The image detection system 404 captures images via the cameras 416 of an area surrounding the vehicle 100. The images are fed to the image look-up algorithm 420 (FIG. 7) via a first electrical signal 502.

In the event the images received from the first electrical signal 502 include the attachment 112, the image look-up algorithm 420 compares the retrieved images to images stored in an attachment image database 504. The attachment image database 504 may be stored in the memory 308 (FIG. 2) and include images of known possible attachments, e.g., a trailer, recreational vehicle, a dolly, or other type of towable vehicle suitable for the vehicle 100. In one example the attachment image database 504 is stored in a cloud network. The images of known possible attachments are fed to the image look-up algorithm 420 via a second electrical signal 506. The second electrical signal 506 may be sent via a wired or wireless connection.

In some aspects, a software update 508 is available to update the attachment image database 504 with any new/most recent towable vehicles suitable for the vehicle 100. The software update 508 may be an over the air (OTA) update. The software update 508 may be automatic. The software update 508 may be initiated manually, via, the user interface 224. The software update 508 may be communicated via a third electrical signal 510. The software update 508 may include updates for the entire parking system 400 and/or any other system of the vehicle 100.

Upon completion, the image look-up algorithm 420 outputs data associated with features (FIG. 6) from the attachment image database 504 to the attachment-size algorithm 422 (FIG. 8) via a fourth electrical signal 512. The attachment-size algorithm 422 receives the signal 230 with an attachment status 514. The attachment status 514 may be activated when, by way of example, a user manually inputs that a trailer has been attached to the vehicle 100 via the user interface 224. It is further contemplated that the attachment status 514 is activated by the previously mentioned sensors 216 described herein.

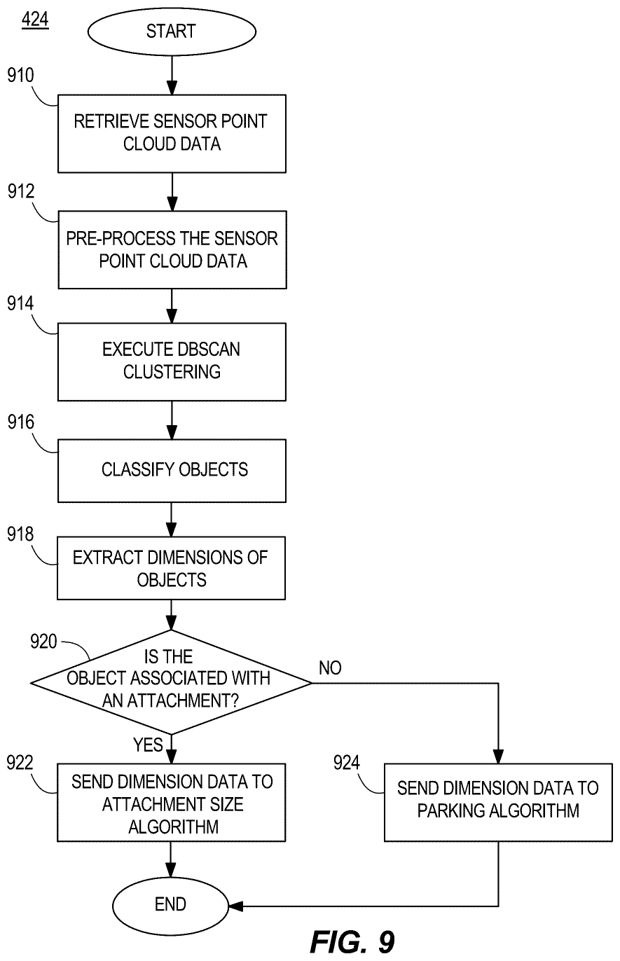

The attachment-size algorithm 422 also receives a fifth electrical signal 516 including attachment size data 518 output by the radar algorithm 424 (FIG. 9) to more accurately determine a size of the attachment 112, e.g., the trailer 114 attached to the vehicle 100. Based on the features and the attachment size data 518, the attachment-size algorithm 422 determines a size of the attachment.

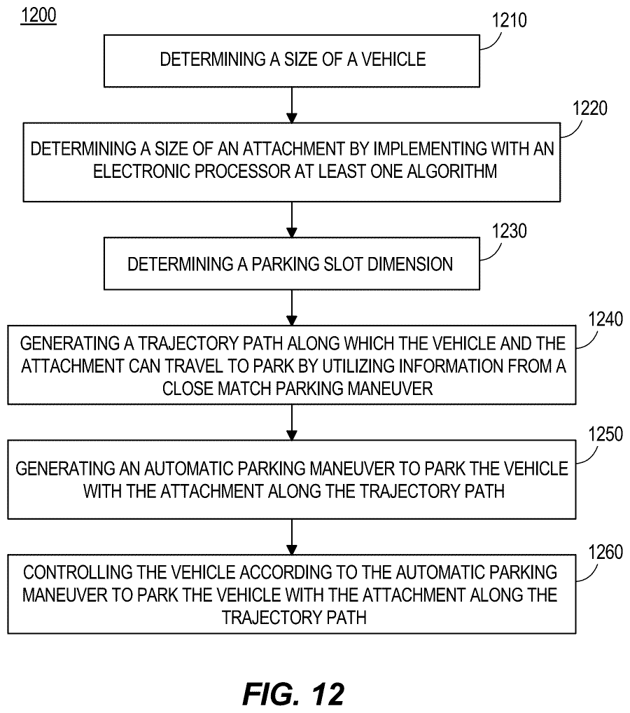

Upon completion, the attachment-size algorithm 422 outputs a sixth electrical signal 520 including the size of the attachment 112 to the parking algorithm 426 (FIG. 12). The parking algorithm 426, when activated, operates to automatically park the vehicle 100 and the attached trailer 114, or other attachment 112.

It should be understood that the electrical signals 230, 502, 506, 510, 512, 516, 520 described herein may be communicated via wired or wireless connections.

FIG. 6 illustrates a schematic for the attachment image database 504. The attachment image database 504 may be a feature look-up table 610 where a database image 612 associated with a specific type of attachment 112 corresponds to a set of features 614 for that type of attachment 112. The type of attachment 112 may include, e.g. a closed trailer 612a, a flatbed trailer 612b, a wheelchair attachment 612c, and a boat trailer 612d. While four database images 612 are illustrated, more or less images are contemplated. The set of features 614 may include the first geometric offset Lₓ, the second geometric offset W_{y}, and the third geometric offsent H_{z}. Other features, e.g. mass, material, load capacity, represented by (“X”), are also contemplated as part of the set of features 614.

Turning to FIG. 7, one example of the image look-up algorithm 420 is illustrated.

At step 710 at least one image is retrieved from the cameras 416. The at least one image may be multiple images retrieved from all the cameras 416. The presence of an attachment, e.g., the trailer 114 on a rear 118 of the vehicle 100, is determined at block 712.

At step 714, if the trailer 114 is determined to be attached, the retrieved image is compared to the database images 612 in the attachment image database 504. The presence of a matching image among the database images 612 in the attachment image database 504 is determined at block 716.

At step 718, in the event a matching image exists in the database images 612, the features 614 corresponding to that database image 612 are retrieved from, for example, the feature look-up table 610.

At step 720 the data corresponding to the presence of an attachment 112 and the data associated with the features 614, including the offsets Lₓ, W_{z}, H_{y}, are sent to the attachment-size algorithm 422.

At step 722, if no attachment is present, an absence of an attachment is sent to the attachment-size algorithm 422.

At step 724, if a matching image is not present in the attachment image database 504, an absence of the corresponding data is sent to the attachment-size algorithm 422.

FIG. 8 illustrates one example of the attachment-size algorithm 422.

At step 810 the attachment status 514 is retrieved, for example from the image look-up algorithm 420. The presence of an attachment 112, e.g., the trailer 114, is determined at block 812.

At step 814 a first size data, by way of example the offsets Lₓ, W_{z}, H_{y}, from step 720 of the image look-up algorithm 420, is retrieved.

At step 816 a second size data is retrieved. The second size data is representative of features about the attachment 112 determined by the radar algorithm 424, explained in more detail in FIG. 9.

At step 818 the first size data is compared to the second size data to determine an actual size for the trailer 114. For example, if the first size data is greater than the second size data, the first size data is selected as the actual size data.

At step 820 the offsets Lₓ, W_{z}, H_{y}, for the parking maneuver software 316 are determined.

At step 822 the size of the vehicle and the attachment together are determined. This new size is used in the parking algorithm.

In the event no attachment is present at block 812, at step 824 a default offset for the parking maneuver software 316 is determined. The default offset is based on, for example, the distance from the back of the vehicle to the back of an attachment and is therefore equal to zero in the event no attachment is present.

FIG. 9 illustrates one example of the radar algorithm 424.

At step 910 sensor point cloud data is retrieved. By way of example, the sensor point cloud data is retrieved from the long-range radar 408.

At step 912 the sensor point cloud data is pre-processed.

At step 914 a density-based clustering, e.g., Density-Based Spatial Clustering of Applications with Noise, (DBSCAN) is executed. Density-based clustering is a machine learning technique that identifies clusters in data by finding areas of high point density separated by areas of low density. With DBSCAN, the processed data points are grouped into clusters based on their proximity to each other. Points considered “nearby neighbors” are grouped together, and points that are not grouped are marked as outliers.

At step 916 objects are classified based on the clustering. For example, objects are classified into static objects (e.g., grouped data points), and dynamic objects (e.g., outliers).

At step 918 features associated with the objects are extracted. The grouped data points may together define a curb, other vehicle, recess, the attachment, etc. The outliers may define pedestrians, blowing leaves, a moving animal, etc. The space between the grouped data points may define a space in which the vehicle and attachment can park, e.g. a parking slot 1020 (FIG. 10). Whether or not the classified objects are associated with the attachment 112 is determined at block 920. By way of example, the sensor point cloud data may be processed into moving and static raw data in a bird's eye view (BEV) to represent a surrounding area of the vehicle 100.

At step 922, features associated with the attachment 112 are sent to the attachment-size algorithm 422. In the event no matching image is found in the attachment image database 504, as described in step 722 (FIG. 7), features determined here at step 922 can be used.

At step 924, dimensions associated with parking slots, static objects, and dynamic objects are sent to the parking algorithm 426.

FIG. 10 illustrates one example of stored parking maneuver information 1000. The stored parking maneuver information 1000 may be organized in a maneuver look-up table 1010. The maneuver look-up table 1010 may include existing parking maneuvers 1012 the vehicle 100 has been programmed to take when no attachment is present. The existing parking maneuvers 1012 include, by way of example, a rearward parking maneuver 1014 and a forward parking maneuver 1016. The existing parking maneuvers 1012 may be learned and/or preferred parking maneuvers based on a user's driving habits. Each existing parking maneuver 1012 includes a trajectory path 1018 the vehicle 100 needs to take to park, either rearwardly or forwardly in a parking slot 1020 without an attachment. While not illustrated, it should be understood that other existing parking scenarios, e.g., parallel parking, fishbone parking, angle parking, curb parking can also be part of the stored parking maneuver information 1000.

In the event the attachment 112 is detected, the close match parking maneuver 1022 corresponding to the existing parking maneuvers 1012 may be derived. In some instances, the electronic processor 406 determines, which of the rearward or forward parking maneuvers 1014, 1016 should be selected. For example, the electronic processor 406 may store attachment offset values, e.g., as part of the set of features 614, that correspond to needed spacing for each of the rearward and forward parking maneuvers 1014, 1016. The electronic processor 406 may determine the preferred maneuver for the vehicle 100 by calculating the needed spacing from sensor data, or by receiving the calculated needed spacing from another computing device in the vehicle 100. In response to determining the close match parking maneuver 1022, the electronic processor 406 generates an automatic parking maneuver based on the trajectory path 1018 of the close match parking maneuver 1022. A user may be given an option to select the generated parking maneuver, and, upon selecting the generated parking maneuver, control the vehicle to park the vehicle with the attachment.

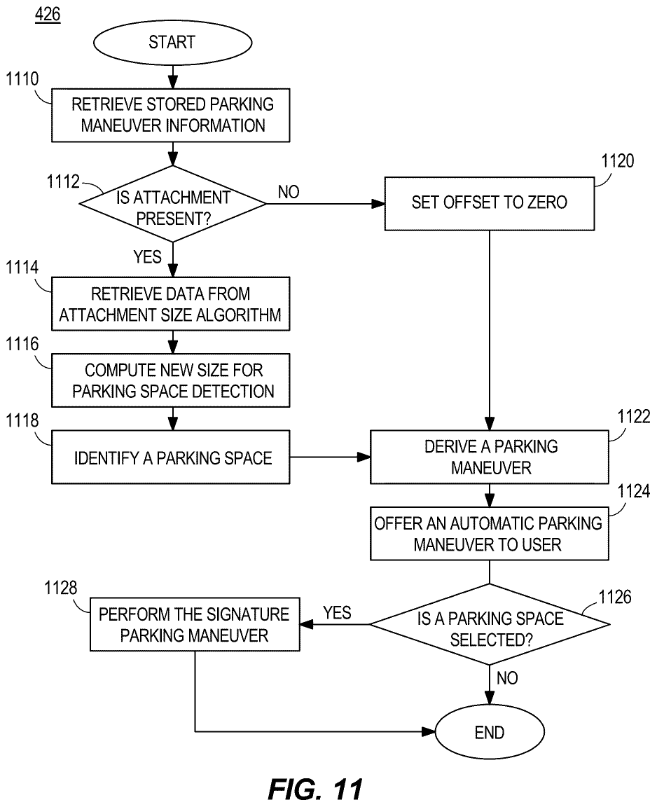

FIG. 11 illustrates one example of the parking algorithm 426.

At step 1110 the parking maneuver information 1000 is retrieved. By way of example, the parking maneuver information 1000 is retrieved from the memory 308. Whether or not the attachment 112 is present is determined at block 1112 by any method previously described herein.

At step 1114, if the attachment 112 is present, data from the attachment-size algorithm 422 is retrieved.

At step 1116, based on the data retrieved, a new size for the parking slot dimension PS is computed.

At step 1118, a suitable parking slot 1020 is identified.

At step 1120, if the attachment 112 is not present, the offset is set to zero.

At step 1122, given the suitable parking slot 1020 or the zero offset, a parking maneuver is derived. The parking maneuver may be derived from the close match parking maneuver 1022 as described herein or generated based on the suitable parking slot 1020.

At step 1124, an automatic parking maneuver is offered to a user as a selectable option. The automatic parking maneuver may be a new parking maneuver, the same as the close match parking maneuver 1022, or a variation of the close match parking maneuver 1022. For example, a graphic illustrating multiple suitable spaces for parking with a graphic corresponding to a selection of a space is displayed on the user interface 224. Whether or not a parking slot 1020 is selected is determined at block 1126.

At step 1128, if a parking slot 1020 is selected, the automatic parking maneuver is performed to move the vehicle 100 or the vehicle 100 with the attachment 112 into the selected parking slot 1020. In one example, the electronic processor 104 is configured to control the vehicle steering system when the option is selected.

FIG. 12 illustrates an example method 1200 for automatically parking a car. The method 1200 is executed by, for example, the electronic processor 406 in conjunction with other components of the vehicle 100 (e.g., the vehicle sensors 216, the vehicle control systems 208, the motor 212, etc.). In some instances, the electronic processor 406 initiates execution of the method 1200 based on surroundings of the vehicle 100. For example, the GPS may be utilized to determine the vehicle is slowly traveling in a parking lot. In another example, the cameras 416 record parking lines and/or the long-range radar senses vehicles spaced at predetermined spacing indicating a parking lot.

The method includes at step 1210 determining a size of the vehicle 100. For example, the size of the vehicle 100 may be retrieved from the memory 308.

At step 1220 determining a size of the attachment 112. For example, the size of the attachment may be determined by implementing the attachment-size algorithm 422 described herein. Implementing the attachment-size algorithm 422 may include implementing the image-look up algorithm 420 and/or the radar algorithm 424 may be implemented.

At step 1230, determine the parking slot dimension PS.

At step 1240 generating the trajectory path 1018 along which the vehicle 100 and attachment 112 can travel to park. For example, generating the trajectory path 1018 with an optimized Rapidly Exploring Random Tree (RRT*) Algorithm and utilizing the close match parking maneuver 1022 described herein to maneuver the vehicle 100 and attachment 112 into the parking slot 1020.

At step 1250 generating the automatic parking maneuver to park the vehicle with the attachment along the trajectory path 1018. For example, indicating on the user interface 224 the option to begin the automatic parking maneuver.

At step 1260 controlling the vehicle according to the automatic parking maneuver to park the vehicle with the attachment along the trajectory path. For example, when the option to utilize the automatic parking maneuver is chosen by a user.

In the foregoing specification, specific examples have been described. However, one of ordinary skill in the art appreciates that various modifications and changes can be made without departing from the scope of the claimed subject matter. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting example the term is defined to be within 10%, in another example within 5%, in another example within 1% and in another example within 0.5%. The term “coupled” as used herein is defined as connected, although not necessarily directly and not necessarily mechanically. A device or structure that is “configured” in a certain way is configured in at least that way but may also be configured in ways that are not listed.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Additionally, unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

It should also be understood that although certain drawings illustrate hardware and software located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations, for example, collectively. To reiterate, those electronic processors and processing may be distributed.

What is claimed is:

1. A system for parking a vehicle with an attachment, the system comprising:
a plurality of vehicle sensors configured to sense data related to a vehicle steering system that includes a motor and a steering rack; and
an electronic processor communicatively connected to the plurality of vehicle sensors and configured to:
determine a size of the vehicle;
determine a size of the attachment;
determine a parking slot dimension;
generate a trajectory path along which the vehicle and attachment can travel to park in a parking slot;
generate an automatic parking maneuver based on the trajectory path; and
control the vehicle to park the vehicle with the attachment.

2. The system of claim 1, wherein the plurality of vehicle sensors includes a camera and the system further comprises an image detection system including the camera for capturing images of an area surrounding the vehicle.

3. The system of claim 2, wherein the camera is multiple cameras including a top view camera, a rear-view camera, a side view camera, and a front view camera.

4. The system of claim 2, further comprising an attachment image database, wherein an image look-up algorithm is configured to compare the images captured by the camera to database images from the attachment image database and, in an event a matching image is found in the database images, output a set of features associated with the matching image.

5. The system of claim 4, wherein the image look-up algorithm outputs a first size of the attachment according to the set of features associated with the matching image.

6. The system of claim 5, wherein the attachment image database comprises a look-up table including the database images of a plurality of attachments and the set of features corresponding to each of the plurality of attachments.

7. The system of claim 5, wherein the plurality of vehicle sensors includes a long-range radar, and the electronic processor is configured to execute a radar algorithm for processing data captured by the long-range radar, wherein the radar algorithm is configured to output a second size of the attachment.

8. The system of claim 7, wherein the electronic processor is configured to execute an attachment-size algorithm comparing the first size of the attachment to the second size of the attachment to determine a likely size of the attachment.

9. The system of claim 7, wherein the data captured is sensor point cloud data, and executing the radar algorithm comprises DBSCAN clustering using the sensor point cloud data.

10. The system of claim 1, wherein the plurality of vehicle sensors includes a long-range radar, and the electronic processor is configured to execute a radar algorithm for processing data captured by the long-range radar, wherein the radar algorithm is configured to output a second size of the attachment.

11. The system of claim 1, further comprising a user interface, wherein the electronic processor is configured to provide the automatic parking maneuver as an option to a user via the user interface, and wherein the electronic processor is configured to control the vehicle steering system when the option is selected.

12. A method for automatically parking a vehicle, the method comprising:
determining a size of the vehicle;
determining a size of an attachment attached to the vehicle by implementing, with an electronic processor, at least one algorithm;
generating a trajectory path along which the vehicle and the attachment can travel to park;
generating an automatic parking maneuver with the trajectory path; and
controlling the vehicle according to the automatic parking maneuver to park the vehicle with the attachment along the trajectory path.

13. The method of claim 12, further comprising capturing images of an area surrounding the vehicle with an image detection system comprising a camera.

14. The method of claim 13, wherein implementing at least one algorithm comprises implementing an image look-up algorithm comprising comparing the images captured by the camera to database images from an attachment image database and, in an event a matching image is found in the database images, outputting a feature associated with the matching image.

15. The method of claim 14, wherein determining the size of the attachment with the image look-up algorithm comprises outputting a first size of the attachment according to the feature associated with the matching image.

16. The method of claim 15, wherein determining the size of the attachment comprises implementing the image look-up algorithm and a radar algorithm.

17. The method of claim 16, further comprising capturing data associated with the area surrounding the vehicle with a long-range radar, wherein the radar algorithm is configured to output a second size of the attachment.

18. The method of claim 17, further comprising implementing, with the electronic processor, an attachment-size algorithm comparing the first size of the attachment to the second size of the attachment to determine a likely size of the attachment.

19. The method of claim 12, deriving a close match parking maneuver corresponding to an existing parking maneuver.

20. The method of claim 19, providing the automatic parking maneuver based on the close match parking maneuver as an option to a user via a user interface, wherein the electronic processor is configured to control a vehicle steering system when the option is selected.
